(19) United States
(12) Patent Application Publication
(10) Pub. No.: US 2015/0097641 A1
(43) Pub. Date: Apr. 9, 2015

(54) SWITCH ASSEMBLY FOR ELECTRIC TOOL

(71) Applicant: Tranmax Machinery Co., Ltd., Taichung City (TW)

(72) Inventor: HSIN-CHI CHEN, TAICHUNG CITY (TW)

(73) Assignee: TRANMAX MACHINERY CO., LTD., Taichung City (TW)

(21) Appl. No.: 14/103,335

(22) Filed: Dec. 11, 2013

(30) Foreign Application Priority Data
Oct. 4, 2013 (TW) 102218679

(51) Int. Cl. H01H 51/27; H01H 50/16; B25F 5/02

(52) U.S. Cl. CPC H01H 51/27; B25F 5/02; H01H 50/16
USPC 335/126

(57) ABSTRACT

A switch assembly includes a circuit board mounted in the housing of an electric tool and carrying multiple magnetic sensor components, a first button having hooks slidably coupled to the circuit board and a press portion exposed to the outside of the housing for pressing by a user and a first magnetic member mounted at the press portion and movable with the first button relative to the housing to induce and change the magnetic flux of one magnetic sensor component, and a second button mounted in the housing and movable back and forth relative to the housing and carrying a second magnetic member that is movable with the second button to induce and change the magnetic flux of the other magnetic sensor component.

### BACKGROUND OF THE INVENTION

1. Field of the Invention

The present invention relates to electric tool technology, and more particularly to a switch assembly for electric tool.

2. Description of the Related Art

The operation of a conventional electric tool is to press the trigger at the handle, starting the motor to rotate the tool bit for working. TWI269695 discloses a trigger switch device for electric tool, which comprises a trigger knob pressable by a user to selectively move conducting plates in conducting different switches in different electronic loops, achieving different operational functions.

For example, when going to drive the motor for rotating the attached tool bit to lock a screw, the user directly presses the trigger knob to start the motor, rotating the screw synchronously. If you want to loosen a screw, the cited patent provides a change-over switch operable through a switching knob to control the direction of rotation of the motor subject to the user's need.

The trigger switch device of the cited patent uses multiple components to achieve control of the operation of the motor, complicating the component assembly process and relatively increasing the overall cost of the electric tool. Further, the control circuit consisting of different metal conducting plates and metal adapter plates is still not satisfactory in function. After a long use, the manufacturing variability or structural fatigue of the components and other factors can affect the reliability and service life of the trigger switch device.

### SUMMARY OF THE INVENTION

The present invention has been accomplished under the circumstances in view. It is the main object of the present invention to provide a switch assembly for electric tool, which has the characteristics of streamlined component composition, high degree of component reliability, ease of installation, short manufacturing time, reduced overall cost and long service life.

To achieve this and other objects of the present invention, a switch assembly of the present invention used in a housing of an electric tool, comprising a circuit board, a first button and at least one second button. The circuit board is mounted inside the housing, comprising at least two magnetic sensor components electrically connected to a board surface thereof. The first button is mounted in the housing, comprising a press portion exposed to the outside of the housing for pressing by a user and defining a top wall, retaining means located at the top wall of the press portion and coupled to the circuit board for allowing the first button to be moved by a user along the circuit board, and first magnetic member mounted at the press portion and movable with the first button relative to the housing to induce and change the magnetic flux of one magnetic sensor component. The at least one second button is mounted in the housing and movable back and forth relative to the housing, each comprising a second magnetic member movable with the respective second button to induce and change the magnetic flux of the other magnetic sensor component. Based on this structural arrangement, the switch assembly has the characteristics of streamlined component composition, high degree of component reliability, ease of installation, short manufacturing time, reduced overall cost and long service life.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 is an elevational view of an electric tool using a switch assembly in accordance with the present invention.

FIG. 2 is an exploded view of the electric tool shown in FIG. 1, illustrating the arrangement of the switch assembly inside the electric tool.

FIG. 3 is an exploded view of the electric tool shown in FIG. 1, illustrating an exploded status of the switch assembly.

FIG. 4 is a sectional view taken along line 4-4 of FIG. 1, illustrating a status of the first button before pressing.

FIG. 5 is similar to FIG. 4, illustrating the first button pressed.

FIG. 6 is a sectional view taken along line 6-6 of FIG. 1, illustrating a status of the positioning means of the two second buttons coupled together.

FIG. 7 is similar to FIG. 6, illustrating a spring member set between the two second buttons.

FIG. 8 is similar to FIG. 7, illustrating one second button pressed.

### DETAILED DESCRIPTION OF THE INVENTION

At first, the applicant must declare that, in the preferred embodiment and related drawings to be introduced hereinafter, like reference signs denote like component parts. Further, when describing mounting of one element in another element, it means that one element is disposed directly on the other element, or the element is indirectly on the other element, i.e., one or many other elements are arranged between the two elements.

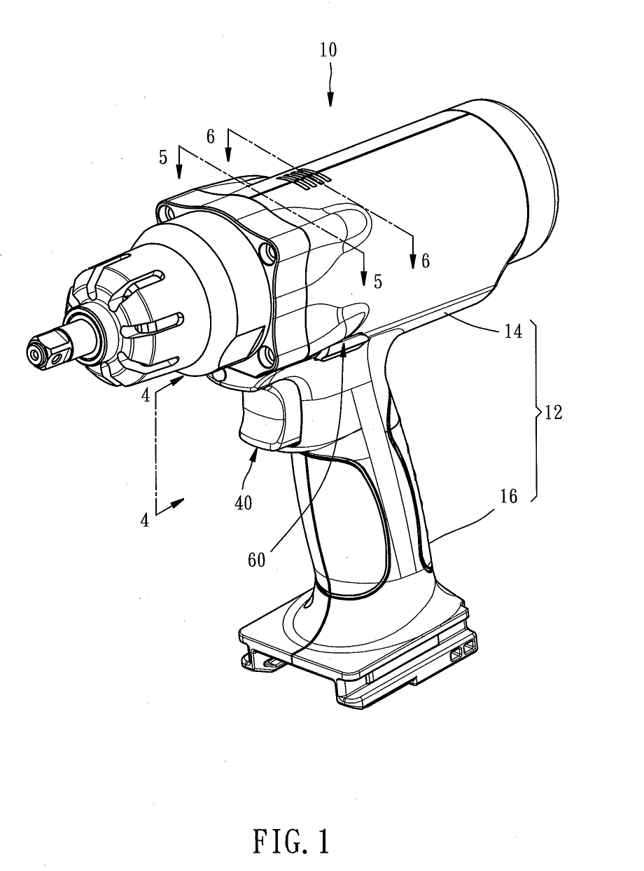

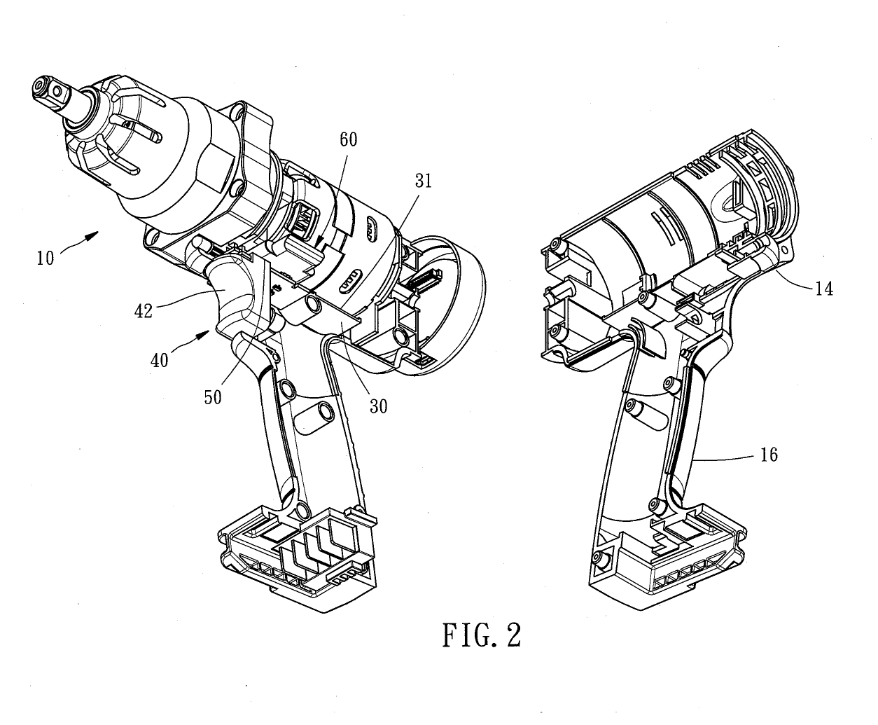

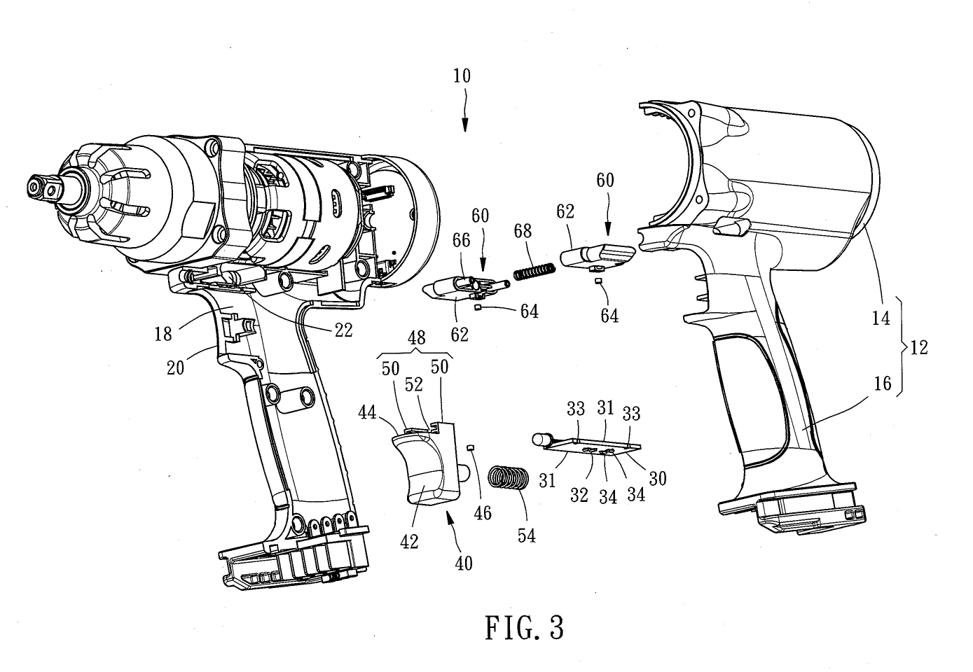

Referring to FIGS. 1-4, a switch assembly in accordance with the present invention is shown installed in an electric tool, such as electric screwdriver, electric grinder or electric drill, for controlling the operation of a drive motor. The electric tool 10 comprises a housing 12. The housing 12 comprises a base portion 14, a handheld portion 16 extended from a bottom side of the base portion 14, an accommodation chamber 18 defined in between the base portion 14 and the handheld portion 16, an opening 20 located on a front side of the handheld portion 16 in communication with the accommodation chamber 18, and a passageway 22 cut through two opposite sides of the base portion 14 and disposed adjacent to and above the opening 20.

The switch assembly comprises a circuit board 30, a first button 40, and at least one second button 60. The circuit board 30 exhibits an elongated shape, having two opposite long sides 31. The circuit board 30 has at least two magnetic sensor components 32;34 electrically connected to a board surface thereof. In this embodiment, the number of the magnetic sensor components is 4, and these magnetic sensor components are Hall components, wherein two magnetic sensor components 32, hereinafter called as first magnetic sensor components, are spaced along the longitudinal direction of the circuit board 30; the other two magnetic sensor components 34, hereinafter called as second magnetic sensor components, are spaced along the transverse direction of the circuit board 30. The circuit board 30 is mounted within the accommodation chamber 18 of the housing 12 to force mounting grooves 33 at one long side 31 into engagement with an inside wall of the housing 12.

The first button 40 comprises a press portion 42 defining a top wall 44, a first magnetic member 46 mounted at the top wall 44 of the press portion 42, and retaining means 48 located at the top wall 44 of the press portion 42. In this embodiment, the first magnetic member 46 is a permanent magnet; the retaining means 48 comprises two hooks 50 extended from the top wall 44 of the press portion 42 and defining therebetween a guide groove 52. The first button 40 is coupled to the circuit board 30 by hooking the two hooks 50 on the two opposite long sides 31 of the circuit board 30, keeping the circuit board 30 in the guide groove 52. Thus, the first button 40 can be mounted in the housing 12 and movable along the circuit board 30, keeping a part of the press portion 42 exposed to the outside of the opening 20 for operation by a user to control the operation of the electric tool 10. Further, a compression spring 54 is set between the inner surface of the press portion 42 and the housing 12, allowing the first button 40 to be moved back and forth relative to the housing 12. Further, after installation of the first button 40 in the housing 10, the first magnetic member 46 is kept below the first magnetic sensor components 32.

The number of the at least one second button 60 in this embodiment is 2. Each second button 60 comprises a body 62, a second magnetic member 64 mounted at the body 62, and positioning means 66 located on the body 62. In this embodiment, the second magnetic member is a permanent magnet; the positioning means 66 of one second button 60 comprises two pins; the positioning means 66 of the other second button 60 comprises two pin holes. The two second buttons 60 are coupled together by means of the respective positioning means 66, and then mounted in the passageway 22 of the housing 12 in a slidable manner relative to each other. After installation, each second button 60 has a part thereof exposed to the outside of the housing 12, keeping the respective second magnetic member 64 to face toward one respective second magnetic sensor component 34. Further, a spring member 68 is set between the two second buttons 60. As the bodies 62 of the second buttons 60 are slidably coupled together by means of the respective positioning means 66 and respectively stopped against the spring member 68, each second button 60 can be separately moved back and forth in the passageway 22 relative to the housing 12.

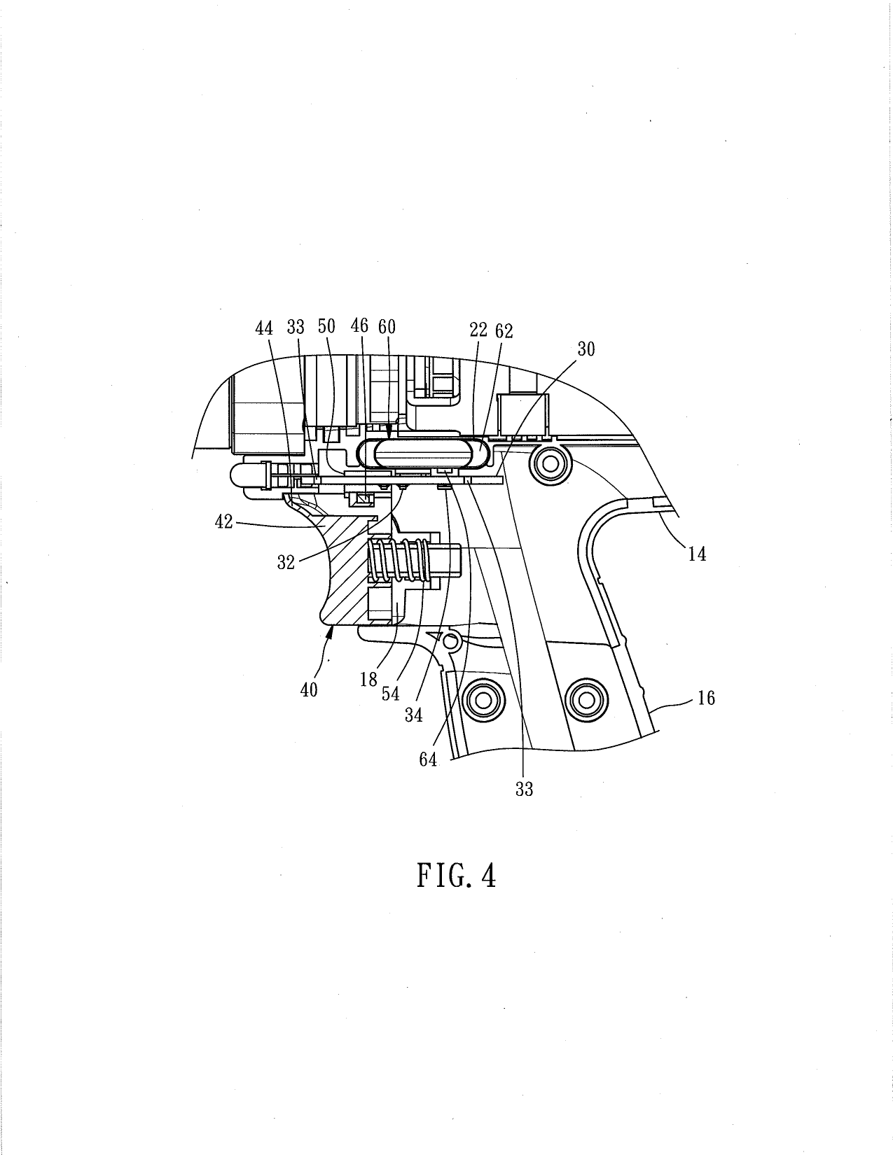

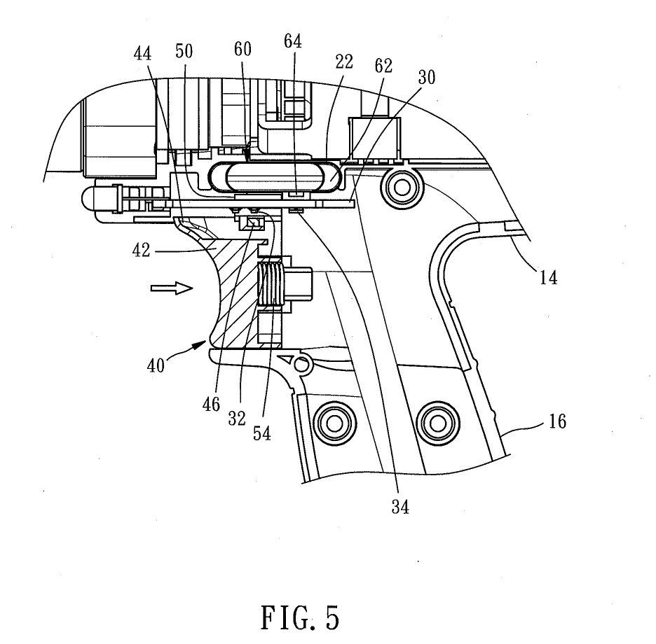

Based on the composition of the above-described components of the present invention, when the first button 40 is not pressed, as shown in FIG. 4, the first magnetic member 46 is disposed at an outer side relative to the first magnetic sensor components 32. When the first button 40 is pressed, as shown in FIG. 5, the first button 40 is moved with the retaining means 48 along the two opposite long sides 31 of the circuit board 30 toward the inside of the housing 12 to carry the first magnetic member 46 over the first magnetic sensor components 32, causing a change in the magnetic flux of the first magnetic sensor components 32 and further generation of an electrical signal for controlling rotation of the motor.

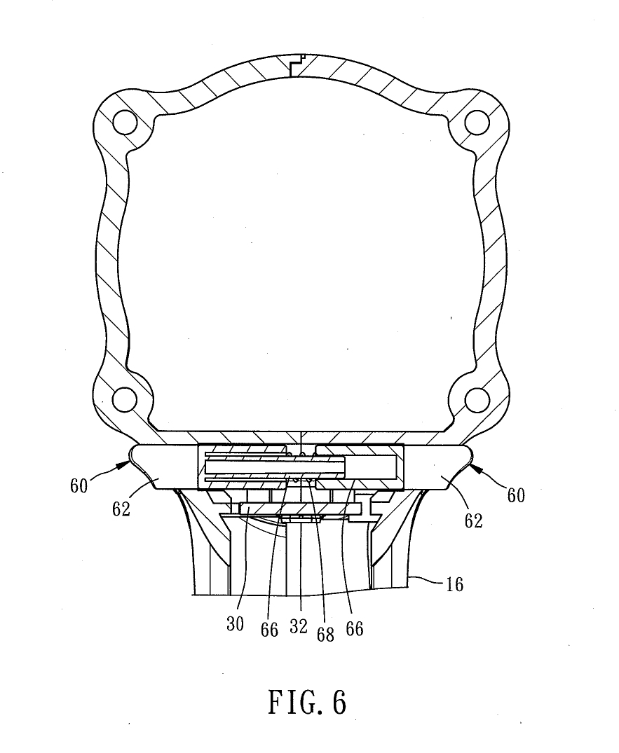

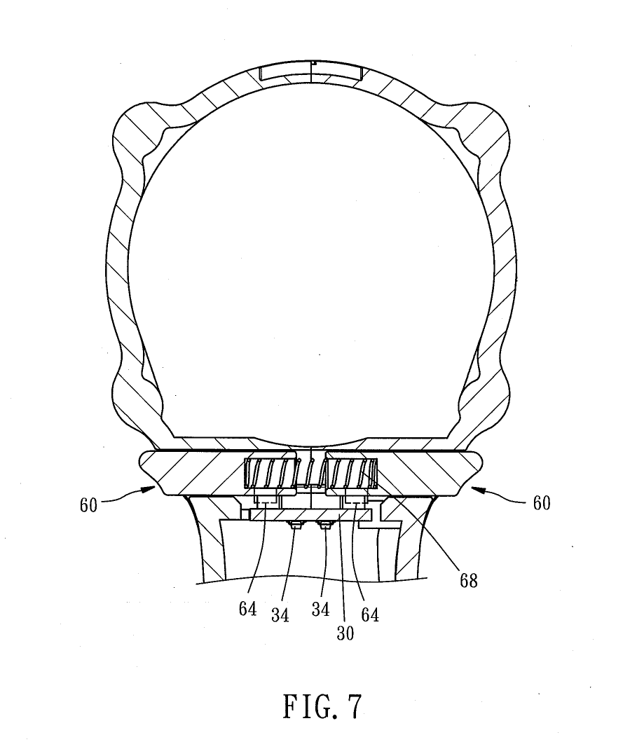

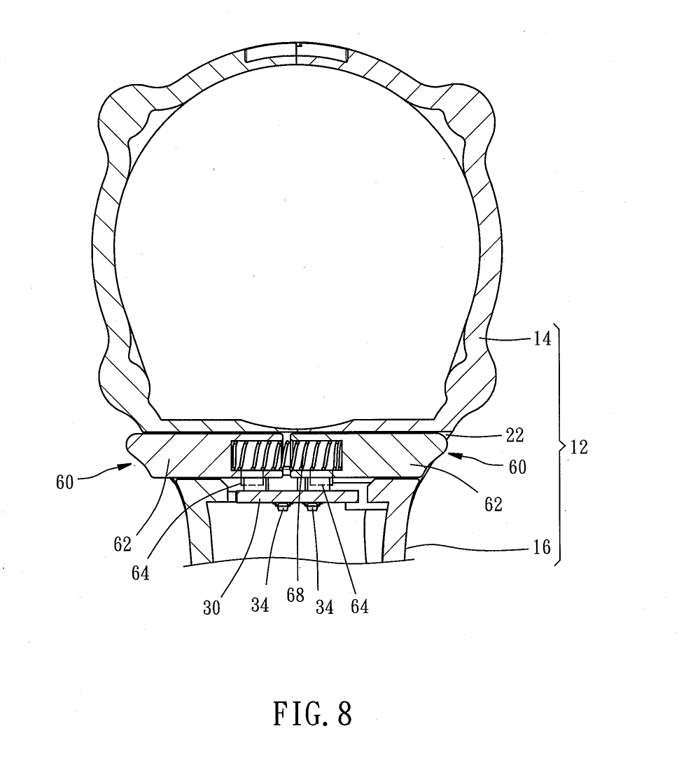

Referring to FIGS. 6-8, because the two second buttons 60 are mounted in the housing 12 at two opposite sides and coupled together by means of the respective positioning means 66 for allowing sliding movement relative to each other, a user can reverse the rotation of the motor simply by pressing one second button 60 to move the respective second button 60 along the passageway 22 toward the inside of the housing 12 in carrying the respective second magnetic member 64 close to and over the second magnetic sensor components 34. When the first magnetic member 46 is moved over the first magnetic sensor components 32, a change in the magnetic flux of the first magnetic sensor components 32 is produced, causing generation of an electrical signal for controlling forward or backward rotation of the motor.

When compared with the prior art techniques, the technical features of the present invention achieve the following effects:

1. The retaining means 48 of the first button 40 is coupled to the two opposite long sides 31 of the circuit board 30 for enabling the circuit board 30 to guide sliding movement of the first button 40, and the first magnetic member 46 is arranged to induce the magnetic sensor components 32 in a non-contact manner for controlling the direction of rotation of the motor directly. The invention simplifies the motor control component composition, using a less number of components, saving much electric tool assembly time and reducing the related costs.

2. The operation method of using one single circuit board 30 to match with one first button 40 and at least one second button 60 enables the second magnetic member 64 of each second button 60 to induce the second magnetic sensor components 34 in a non-contact manner for controlling forward/backward rotation of the motor without any extra change-over switch.

3. Using the switch assembly in an electric tool allows change between forward and backward rotation of the motor simply by repeatedly pressing the second button 60; regardless the electric tool is at any working location or under any working environment, a user can operate the second button 60 conveniently without any trouble.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A switch assembly used in a housing of an electric tool, the switch assembly comprising:
a circuit board mounted inside said housing, said circuit board comprising at least two magnetic sensor components electrically connected to a board surface thereof;
a first button mounted in said housing, said first button comprising a press portion exposed to the outside of said housing for pressing by a user and defining a top wall, retaining means located at said top wall of said press portion and coupled to said circuit board for allowing said first button to be moved by a user along said circuit board, and first magnetic member mounted at said press portion and movable with said first button relative to said housing to induce and change the magnetic flux of one said magnetic sensor component; and
at least one second button mounted in said housing and movable back and forth relative to said housing, each said second button comprising a second magnetic member movable with the respective said second button to induce and change the magnetic flux of the other said magnetic sensor component.

2. The switch assembly as claimed in claim 1, wherein said retaining means of said first button comprises two hooks respectively slidably hooked on two opposite sides of said circuit board, and a guide groove defined between said two hooks for receiving said circuit board.

3. The switch assembly as claimed in claim 1, wherein the number of said second button is 2, each said second button comprising a body and positioning means located at said body, the positioning means of said two second buttons being coupled together for allowing relative movement between said two second buttons in said housing.

4. The switch assembly as claimed in claim 3, wherein the positioning means of one said second button comprises at least one pin; the positioning means of the other said second button comprises at least one pin hole slidably coupled to said at least one pine.

5. The switch assembly as claimed in claim 3, further comprising a spring member set between said two second buttons for enabling each said second button to be separately moved back and forth relative to said housing.
